(19) United States
(12) Patent Application Publication
(10) Pub. No.: US 2026/0025601 A1
(43) Pub. Date: Jan. 22, 2026

(54) SOLID-STATE IMAGING DEVICE FOR ENCODED READOUT AND METHOD OF OPERATING THE SAME

(71) Applicant: Sony Semiconductor Solutions Corporation, Kanagawa (JP)

(72) Inventor: Erik Robert JOHANSSON, Stuttgart (DE)

(73) Assignee: Sony Semiconductor Solutions Corporation, Kanagawa (JP)

(21) Appl. No.: 18/995,270

(22) PCT Filed: Jun. 20, 2023
(86) PCT No.: PCT/EP2023/066521

§ 371 Date: Jan. 16, 2025

(30) Foreign Application Priority Data
Jul. 25, 2022 (EP) 22186685.8

(51) Int. Cl. H04N 25/78; H04N 25/77

(52) U.S. Cl. CPC H04N 25/78; H04N 25/77

(57) ABSTRACT

A solid-state imaging device includes a pixel array, which includes pixel circuits, and a plurality of column readout circuits. Each pixel circuit is assigned to one of N pixel columns and to one of M pixel rows. Each pixel circuit generates a pixel signal containing pixel illumination information. Depending on a signal level of a row encoding signal, each pixel circuit outputs the pixel signal on a first data signal line or on a second data signal line. Each column readout circuit generates a first code signal by superimposing the pixel signals transmitted on the first data signal line, generates a second code signal by superimposing the pixel signals transmitted on the second data signal line, and generates a differential signal from the first code signal and the second code signal.

The present disclosure relates to a solid-state imaging device having pixel circuits suitable for an encoded readout method. More specifically, the disclosure relates to encoding pixel signals from pixel circuits of a two-dimensional pixel array. The present disclosure further relates to a method of operating a solid-state imaging device. in particular, to a readout method encoding the pixel signals.

### BACKGROUND

Image sensors in solid-state imaging devices include photoelectric conversion elements that generate a photocurrent whose current rating is proportional to the received radiation intensity. In image sensors for intensity readout, a pixel circuit generates a pixel signal based on the photocurrent, and a downstream analog-to-digital converter converts the pixel signal into a digital pixel value. Pixel circuits for event detection sensors such as Dynamic Vision Sensors (DVS) and Event-based Vision Sensors (EVS) respond to changes in light intensity and the image sensor provides information about the position and timing of such events in the imaged scene. The photoelectric conversions elements are usually arranged in a two-dimensional pixel array. Regardless of the pixel type and whether a global shutter or a rolling shutter is used for the exposure, pixel circuits of the intensity readout type are usually sequentially read out row by row. A scanning mode that reads out the pixels row by row is also described for DVS solid-state imaging devices. The readout time per row and the number of rows result in the frame readout period required to read out one complete image (“frame”) from the image sensor and the maximum frame rate at which successively captured images can be read out.

With increasing number of pixel circuits in a pixel array, power consumption increases, Using lower operating voltages to reduce power consumption deteriorates the signal-to-noise ratio (SNR) for the pixel readout, Further, with increasing number of pixel rows, the frame readout period increases and the frame rate decreases. Reducing readout time per pixel row to increase the frame rate may adversely affect readout quality.

### SUMMARY

Nowadays, there is a constant need for solid-state imaging devices that have high frame rates, high SNR for image readout, and simple pixel circuits. The present disclosure has been made in view of the above circumstances, and it is therefore desirable to provide a solid-state imaging device which, based on proven and tested pixel circuit designs, enables high frame rates with high SNR for image readout.

In this regard, the present disclosure relates to a solid-state imaging device that includes a pixel array and a plurality of column readout circuits. The pixel array includes pixel circuits, wherein each pixel circuit is assigned to one of N pixel columns and to one of M pixel rows. Each pixel circuit generates a pixel signal containing pixel illumination information. Depending on a signal level of a row encoding signal, each pixel circuit outputs the pixel signal on a first data signal line or on a second data signal line. Each column readout circuit generates a first code signal by superimposing the pixel signals transmitted on the first data signal line, generates a second code signal by superimposing the pixel signals transmitted on the second data signal line, and generates a differential signal from the first code signal and the second code signal.

The solid-state imaging device enables a method of operating a solid-state imaging device, wherein the method includes sequentially applying a number L of code words of a binary spreading code matrix to pixel columns of a two-dimensional pixel array. Each code word has a code length L and is applied to some or all of the pixel columns simultaneously, with all bits of the code word simultaneously applied to different pixel rows of the two-dimensional pixel array. For each of the pixel columns separately and depending on an element value of the binary spreading code matrix received by the pixel circuit. each pixel circuit outputs a pixel signal to a first data signal line or to a second data signal line. The method further includes generating a differential signal from a first code signal obtained from the pixel signals output to the first data signal line and from a second code signal obtained from the pixel signals output to the second data signal line.

The readout can be repeated with different code words of the binary spreading code for the same group of pixel circuits. wherein a plurality of different differential signals is obtained from the same pixel signals. Each differential signal contains the information about all the original pixel signals of the pixel column. In a later phase, the differential signals can be converted into digital column signals and the digital column signals can be decoded, with the decoding using essentially the same binary spreading code matrix as the encoding. During decoding, a digital value is recovered for each single pixel signal. The entire encoding/decoding process provides a CDMA (code division multiple access) readout for the pixel circuits, with the averaging effect of the CDMA readout increasing the SNR. In other words, for a given number of readouts of the same pixel signal, the CDMA readout delivers the higher SNR.

The extent of the effect depends on the code length. For example, a conventional row-by-row readout requires eight repetitions of a full-frame readout to achieve the same SNR improvement as a CDMA readout with a binary spreading code of code length L=8. In other words, to achieve the same SNR as the method according to the present disclosure, the frame rate for a conventional row-by-row readout is only ⅛ that for the CDMA readout. Furthermore, transmitting the pixel signals of each pixel circuit on two different data signal lines facilitates smooth integration of the CDMA readout into existing pixel arrays with proven and tested pixel circuit designs.

The described embodiments, together with further advantages, will be best understood by reference to the following detailed description taken in conjunction with the accompanying drawings.

### BRIEF DESCRIPTION OF THE DRAWINGS

FIG. 1 is a simplified block diagram illustrating a configuration example of a solid-state imaging device that provides CDMA readout with two data signal lines per pixel column according to an embodiment based on passive pixel circuits.

FIG. 2 is a simplified block diagram illustrating a configuration example of a solid-state imaging device that provides CDMA readout with two data signal lines per pixel column according to an embodiment based on active pixel circuits.

FIG. 3 shows a simplified circuit diagram illustrating pixel circuits connected to the same data signal lines and a simplified time chart for encoding pixel signals according to an embodiment related to passive pixel circuits and a column readout circuit including a differential amplifier with resistive feedback elements.

FIG. 4 shows a simplified circuit diagram illustrating pixel circuits connected to the same data signal lines and a simplified time chart for encoding pixel signals according to an embodiment related to passive pixel circuits and a column readout circuit including a differential amplifier with capacitive feedback elements.

FIG. 5 shows a simplified circuit diagram illustrating pixel circuits connected to the same data signal lines and a simplified time chart for encoding pixel signals according to an embodiment related to active pixel circuits and a column readout circuit including a differential amplifier with capacitive feedback elements.

FIG. 6 is a simplified block diagram illustrating the encoding of pixel signals of a pixel array into column signals and the decoding of the column signals into the original pixel signals, in accordance with an embodiment of the present disclosure.

FIG. 7 is a simplified block diagram of a solid-state imaging device for illustrating a readout method including the encoding of pixel signals of a pixel column into column signals and the decoding of the column signals into the original pixel signals, in accordance with an embodiment of the present disclosure.

FIG. 8 to FIG. 10 are simplified block diagrams illustrating different phases of the readout method used in the block diagram of FIG. 7.

FIG. 11A and FIG. 11B schematically show different readout addressing codes for discussing effects of the embodiments of the present disclosure.

FIG. 12A and FIG. 12B schematically show different readout addressing codes in accordance with embodiments of the present disclosure.

FIG. 13 is a diagram showing an example of a laminated structure of a solid-state imaging device according to an embodiment of the present disclosure.

FIG. 14 is a schematic circuit diagram of elements of an image sensor assembly formed on one of two chips of a solid-state imaging device with laminated structure according to an embodiment.

FIG. 15 is a block diagram depicting an example of a schematic configuration of a vehicle control system.

FIG. 16 is a diagram of assistance in explaining an example of installation positions of an outside-vehicle information detecting section and an imaging section of the vehicle control system of FIG. 15.

### DETAILED DESCRIPTION

Embodiments for implementing techniques of the present disclosure will be described below in detail using the drawings. The techniques of the present disclosure are not limited to the described embodiments, and various numerical values and the like in the embodiments are illustrative only. The same elements or elements with the same functions are denoted by the same reference signs. Duplicate descriptions are omitted.

Connected electronic elements may be electrically connected through a direct and permanent low-resistive connection, e.g., through a conductive line. The terms “electrically connected” and “signal-connected” may also include a connection through other electronic elements provided and suitable for permanent and/or temporary signal transmission and/or transmission of energy. For example, electronic elements may be electrically connected or signal-connected through resistors, capacitors, and electronic switches such as transistors or transistor circuits, e.g. MOSFETs. transmission gates, and others.

The load path of a transistor is the controlled path of a transistor. For example, a voltage applied to a gate of a field effect transistor (FET) controls by field effect the current flow through the load path between source and drain of the FET.

Though in the following a technology for encoded pixel readout is predominantly described in the context of certain types of image sensors for intensity readout, the technology may also be used for other types of image sensors, e.g., EVS and DVS.

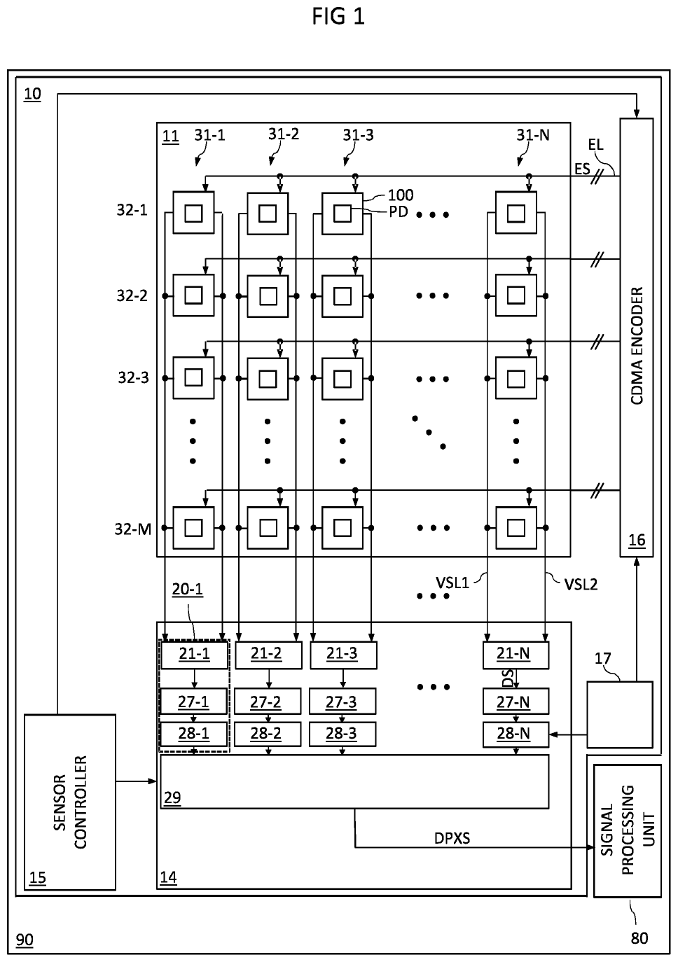

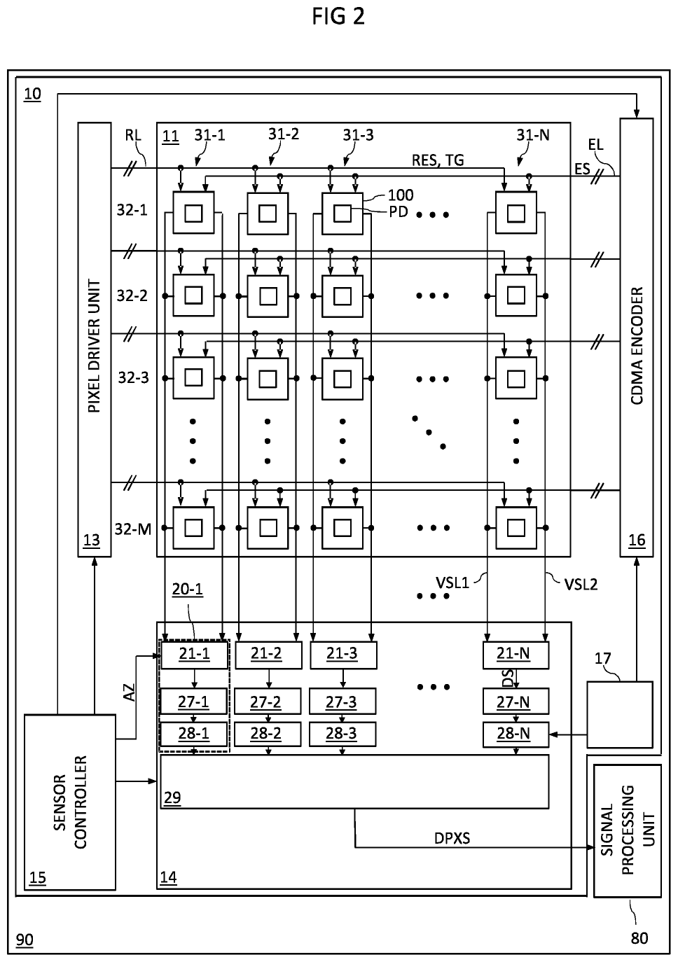

FIG. 1 and FIG. 2 illustrate configuration examples of a solid-state imaging device 90 according to embodiments of the present technology.

The solid-state imaging device 90 includes a pixel array 11 and a plurality of column readout circuits 20. The pixel array 11 includes pixel circuits 100, wherein each pixel circuit 100 is assigned to one of N pixel columns 31 and to one of M pixel rows 32. Each pixel circuit 100 generates a pixel signal containing pixel illumination information. Depending on a signal level of a row encoding signal ES, each pixel circuit 100 outputs the pixel signal on a first data signal line VSL1 or on a second data signal line VSL2. Each column readout circuit 20 generates a first code signal by superimposing the pixel signals transmitted on the first data signal line VSL1. generates a second code signal by superimposing the pixel signals transmitted on the second data signal line VSL2, and generates a differential signal DS from the first code signal and the second code signal.

The same row encoding signal is simultaneously applied to a plurality of pixel circuits 100 of a pixel row 32, e.g., to all pixel circuits 100 of the same pixel row 32. A plurality of different row encoding signals is simultaneously applied to a plurality of pixel circuits 100 of a pixel column 31, e.g. to all pixel circuits 100 of the same pixel column 31 or to all pixel circuits 100 of the pixel array 11.

Each differential signal DS may be obtained by subtracting the first code signal from the second code signal or by subtracting the second code signal from the first code signal. Alternatively. the differential signal DS may be obtained by subtracting a signal obtained from the first code signal from a signal obtained from the second code signal or by subtracting the signal obtained from the second code signal from a signal obtained from the first code signal. Each differential signal DS embodies an encoded analog signal containing information about a plurality of pixel signals, e.g., for all pixel signals of the same pixel column 31.

To this purpose, the pixel array 11 includes a plurality of first data signal lines VSL1 and a plurality of second data signal lines VSL2. Each first data signal line VSL1 electrically connects first pixel outputs of a plurality of pixel circuits 100 with a first input of one of the column readout circuits 20. Each second data signal line VSL2 electrically connects second pixel outputs of the plurality of pixel circuits 100 with a second input of the same column readout circuit 20.

More specifically, the pixel array 11 includes a plurality of signal line pairs, each including one first data signal line VSL1 and one second data signal line VSL2. Each signal line pair may be assigned to one of the pixel columns 31 and each pixel column 31 may be assigned to one signal line pair as illustrated in FIG. 1 and FIG. 2. In particular, the first data signal line VSL1 of each signal line pair electrically connects the first pixel outputs of the pixel circuits 100 of one of the pixel columns 31 with a first input of the column readout circuit 20 assigned to the pixel column 31, and the second data signal line VSL2 of the same signal line pair electrically connects the second pixel outputs of the pixel circuits 100 of the same pixel column 31 with a second input of the column readout circuit 20 assigned to the pixel column 31.

Alternatively, one signal line pair may be assigned to two or more pixel columns 31 so that the pixel circuits 100 of more than on pixel column 31 output pixel signals to the same signal line pair, or the same pixel column 31 may be assigned to two or more signal line pairs so that the pixel circuits 100 of the same pixel column 31 output the pixel signals to different signal line pairs.

Each pixel circuit 100 includes a photoelectric conversion element PD. The photoelectric conversion element PD converts incident electromagnetic radiation into electric charge by the photoelectric effect. The amount of electric charge generated in the photoelectric conversion element PD is a function of the intensity of the incident electromagnetic radiation. The photoelectric conversion element PD may include or consist of a photodiode that converts electromagnetic radiation incident on a detection surface into a detector current (photocurrent). The electromagnetic radiation may include visible light, infrared radiation and/or ultraviolet radiation.

The pixel signals contain pixel illumination information. The pixel illumination information may include information about the radiation intensity and/or about a change of the radiation intensity.

The pixel circuits 100 may be passive pixel circuits that output the detector current as the pixel signal. Alternatively, the pixel circuits 100 may be active pixel circuits having at least one pixel transistor in addition to the photoelectric conversion element PD, wherein the pixel signal is obtained by amplifying, converting and/or buffering the detector current. The pixel transistors are FETs, e.g., MOSFETs (metal oxide semiconductor FETs) and configure the pixels circuits 100 as any active pixel sensors for intensity readout and/or event detection.

The pixel array 11 is a two-dimensional pixel array and forms part of an image sensor assembly 10. Each pixel circuit 100 is part of one pixel column 31 and part of one pixel row 32. The pixel circuits 100 associated with the same pixel column 31 may be arranged along a straight or meandering line in a horizontal plane of a semiconducting pixel substrate. The pixel circuits 100 associated with the same pixel row 32 may be arranged along a straight or meandering line in the horizontal plane of the semiconducting pixel substrate. wherein the pixel rows 32 extend substantially orthogonal to the pixel columns 31. The number M of pixel circuits 100 per pixel column 31 may be less than, equal to, or greater than the number N of pixel columns 31. The number M of pixel circuits 100 per pixel column 31 is equal to the number of pixel rows 32 in the pixel array 11.

The pixel circuits 100 of the same pixel row 32 share common row encoding lines EL as shown in FIG. 1 or may share both common row encoding lines EL and common row control lines RL as shown in FIG. 2.

The row encoding lines EL supply the row encoding signals ES to the pixel circuits 100. Each row encoding line EL may be electrically connected to some pixel circuits 100 of a pixel row 32 or to all pixel circuits 100 of one pixel row 32. One or two row encoding lines EL may be electrically connected to each pixel circuit 100.

The row encoding signals ES control whether in an encoding period a pixel circuit 100 outputs the pixel signal via the first pixel output to a first data signal line VSL1 or via the second pixel output to a second data signal line VSL2.

If one single row encoding signal ES is supplied to the pixel circuit 100, the pixel circuit 100 may output the pixel signal to the first data signal line VSL1 at a voltage level of the row encoding signal ES exceeding a voltage threshold. and the pixel circuit 100 may output the pixel signal to the second data signal line VSL2 at a voltage level of the row encoding signal ES falling below the voltage threshold, or vice versa. For example, the row encoding signal ES is a binary or ternary signal with an active high level and an active low level and the pixel circuit 100 outputs the pixel signal to the first data signal line VSL1 at the active high level of the row encoding signal ES and outputs the pixel signal to the second data signal line VSL2 at the active low level or vice versa.

If two row encoding signals ES are supplied to the pixel circuit 100. the pixel circuit 100 may output the pixel signal to the first data signal line VSL1 only at an active voltage level of the first row encoding signal and may output the pixel signal to the second data signal line VSL2 only at an active voltage level of the second row encoding signal. The second row encoding signal may be the inverted first row encoding signal.

Each pixel circuit 100 spatially encodes the information about non-inverion or inversion of the pixel signal by selecting one of the data signal lines VSL1, VSL2 to which the pixel signal is forwarded. For example, when the row encoding signal ES is active, the pixel circuit 100 outputs the pixel signal to the first data signal line VSL1, thereby encoding the pixel signal as non-inverted pixel signal, and when the row encoding signal ES is inactive, the pixel circuit 100 outputs the pixel signal to the second data signal line VSL2, thereby encoding the pixel signal as inverted pixel signal.

Each column readout circuit 20 may include a differential unit 21 that generates a first code signal by superimposing the pixel signals transmitted on the first data signal line VSL1, generates a second code signal by superimposing the pixel signals transmitted on the second data signal line VSL2, and generates an analog differential signal DS from the first code signal and the second code signal.

The combination of pixel circuits 100 that output a pixel signal either on a first data signal line VSL1 or a second data signal line VSL2 depending of the voltage level of one or more row encoding signals ES and a column readout circuit 20 that generates a differential signal of the pixel signals superposing on the first data signal line VSL1 and the pixel signals superposing on the second data signal line VSL2 enables an encoded readout method. After encoding the same pixel signals using different code words of a suitable binary spreading code, the original pixel signals for each single pixel circuit can be restored from the resulting differential signals without loss of illumination information by digital signal processing in a later phase. For a given frame rate, which is the frequency at which the complete image data is obtained once, the encoded readout method provides higher SNR than conventional row-by-row readout methods.

For example, the solid-state imaging devices 90 may include an encoding unit 16 that controls the row encoding signals ES according to a binary spreading code matrix with a number L of code words having a code length L. wherein the code length L is equal to or smaller than the number M of pixel circuits 100 per pixel column 31.

In particular, the binary spreading code matrix may be a square or non-square matrix with binary elements having a first element value or a second element value different from the first element value. According to an embodiment, the binary spreading code matrix is a square matrix to reduce computational load. For example, the binary spreading code matrix is a square matrix with a number L of code words with a code length L. The number L of code words is equal to or smaller than the number M of pixel circuits 100 per pixel column 31.

Each code word is applied to some or all of the pixel circuits 100 simultaneously. The binary spreading code matrix may be that of an orthogonal spreading code, for example, a Walsh-Hadamard matrix. In particular. the binary spreading code matrix is a square Walsh-Hadamard matrix with a code length L equal to the number M of pixel circuits 100 per pixel column 31, wherein all pixel rows 32-1, . . . , 32-M are addressed and read out simultaneously.

According to another embodiment, the binary spreading code matrix may include a square matrix, in particular a Walsh-Hadamard matrix, with a code length L smaller than the number M of pixel circuits 100 per pixel column 31. For example, the pixel array may include two or more sets of pixel rows 32-1, . . . , 32-L with L<M. The pixel rows of the same set of pixel rows 32-1, . . . , 32-L are addressed and encoded simultaneously. The sets of pixel rows 32-1, . . . , 32-L are addressed and encoded sequentially. Computational load, in particular in a decoding process as explained below. can be reduced. L may be an integer divisor of M.

A memory unit 17 may store the elements of the binary spreading code matrix. The memory unit 17 may include a memory circuit with read-only memory cells or with rewriteable memory cells, by way of example. The element values of the binary spreading code matrix may be noted as “+1” and “−1” and can be directly transformed into suitable row encoding signals changing between two signal levels depending on the element value to be encoded.

For example, the encoding unit 16 converts the element value “+1” into a first signal level (active level) of a single row encoding signal ES and converts the element value “−1” into a second signal level (inactive level) of the single row encoding signal ES, wherein the first signal level causes the addressed pixel circuits 100 to output the pixel signal on the first data signal lines VSL1 and wherein the second signal level causes the addressed pixel circuits 100 to output the pixel signal on the second data signal lines VSL2.

According to another example, the encoding unit 16 may convert the element value “+1” into an active signal level of a first row encoding signal ES and the element value “−1” into an active signal level of a second row encoding signal ES, wherein the active signal level of the first row encoding signal ES causes the addressed pixel circuits 100 to output the pixel signal on the first data signal lines VSL1 and wherein the active signal level of the second row encoding signal level causes the addressed pixel circuits 100 to output the pixel signals on the second data signal lines VSL2.

Each column readout circuit 20 may further include an analog-to-digital conversion unit 27 that converts the analog differential signal DS into an encoded column value.

In particular, the analog-to-digital conversion units 27 convert the analog differential signals DS output by the differential units 21 into digital values representing encoded column values. Each encoded column value contains encoded information about all pixel signals forwarded from the pixel circuits 100 to the column readout circuit 20 connected to the pixel circuits 100.

Each column readout circuit 20 may further include a digital block 28 that sequentially receives a set of the encoded column values and decodes the set of encoded column values by using the binary spreading code matrix, wherein the number of encoded column values per set is equal to the code length L of the binary spreading code matrix. The digital blocks output digital pixel values for the original pixel signals.

In particular, each digital block 28-1, . . . , 28-N receives a set of digital column values from one of the column readout circuits 20-1, . . . , 20-N. The number of digital values per set of digital column values is equal to the code length L of the binary spreading code matrix. Each digital block 28-1, . . . , 28-N decodes the received set of digital column values by using the same binary spreading code matrix as used for decoding the individual pixel signals and outputs L digital pixel values for each of the pixel circuits 100 assigned to the column readout circuit 20.

The digital blocks 28 and the encoding unit 16 may use the same memory unit 17 for obtaining the element values of the binary spreading code matrix as illustrated. According to another example, the digital blocks 28 and the encoding unit 16 may use different memory units with the same or the complementary content.

The digital blocks 28 facilitate decoding of each frame previously encoded by using L different code words of the binary spreading code matrix. The digital blocks 28-1, . . . , 28-N restore the previously encoded pixel signals as digital values.

The column readout circuits 20 form part of a column signal processing unit 14 that further includes an interface unit 29. The interface unit 29 receives the digital pixel values from all pixel columns 31-1, . . . , 31-N and outputs digital frame data DPXS. The digital frame data includes the digital pixel values for all pixel signals obtained in the same exposure period.

The pixel array 11, the column signal processing unit 14, the encoding unit 16, the memory unit 17, and, if applicable. the row driver unit 13 may be formed as part of an image sensor assembly 10.

The image sensor assembly 10 may further include a sensor controller 15 that controls the components of the image sensor assembly 10. The sensor controller 15 may control the timing of the encoding unit 16 and, if applicable, may supply driving timing signals to the row driver unit 13 in FIG. 2. In addition, the sensor controller 15 generates and drives one or more control signals for controlling the column signal processing unit 14, e.g., the column readout circuits 20-1, . . . , 20-N. the digital blocks 28-1, . . . , 28-N. and the interface unit 29. A solid-state imaging device 90 that includes the image sensor assembly 10 may further include a signal processing unit 80 that receives and further processes the digital frame data DPXS.

FIG. 1 shows a solid-state imaging device 90 with passive pixel circuits 100 that are exclusively controlled by the encoding unit 16.

FIG. 2 shows another solid-state imaging device 90 with active pixel circuits 100 controlled by both the encoding unit 16 and a row driver unit 13 that generates row control signals RES, TG, . . . . Row control lines RL electrically connect the row driver unit 13 with the pixel circuits 100 in the pixel array 11. In particular, the row driver unit 13 may include driver/buffer circuits that drive suitable control signals. reference potentials. and/or voltage biases for the pixel transistors in the active pixel circuits 100. The row driver unit 13 may include one or more driver/buffer circuits per pixel row 32. Alternatively, two or more pixel rows 32 or all pixel circuits 100 may share one, some or all of the driver/buffer circuits. A row control signal RES, TG, . . . output by one driver/buffer circuit may be forwarded to corresponding pixel transistors in the same pixel row 32. in some of the pixel rows 32 or in all pixel rows 32. Accordingly, each row control line RL may be electrically connected to some pixel circuits 100 of a pixel row 32, to all pixel circuits 100 of one pixel row 32, to all pixel circuits 100 of a plurality of pixel rows 32, or to all pixel circuits 100 of the pixel array 11.

With the encoding unit 16, the pixel circuits 100 having first pixel outputs connected to first data signal lines VSL1 and second pixel outputs connected to second data signal lines VSL2. and the column readout circuits 20 as described above, the solid-state imaging device 90 enables a method of operating a solid stage imaging device by using a CDMA readout.

A number L of code words of a binary spreading code matrix is sequentially applied to pixel columns 31 of a two-dimensional pixel array 11. Each code word has a code length L. Each code word is applied to some or all of the pixel columns 31 simultaneously. wherein all bits of a code word are simultaneously applied to different pixel rows 32. For each of the pixel columns 31 separately and depending on an element value of the binary spreading code matrix received by the pixel circuit 100, the pixel circuit 100 outputs a pixel signal to a first data signal line VSL1 or to a second data signal line VSL2. A differential signal DS is generated from a first code signal obtained from the pixel signals output to the first data signal line VSL1 and from a second code signal obtained from the pixel signals output to the second data signal line VSL2.

The differential signal DS is generated from a first code signal obtained by superposition of the pixel signals output to the first data signal line VSL1 and from a second code signal obtained by superposition from the pixel signals output to the second data signal line VSL2. The superposition may be linear, wherein superposition includes signal sign multiplication and summation. But for linear superposition, coding with a code word with code elements having the same elemental value (all +1 or all −1), may result in that the output voltage Vo becomes so high that the amplifier output signal is clipped. Superposition using a current-voltage transfer function that is less steep for higher current values than for lower current values can mitigate shortcomings of a purely linear superposition. For example, the superposition may be non-linear, e.g. completely logarithmic, linear up to a threshold and logarithmic beyond the threshold, or linear with a first inclination up to a threshold and linear with a second, lower inclination beyond the threshold.

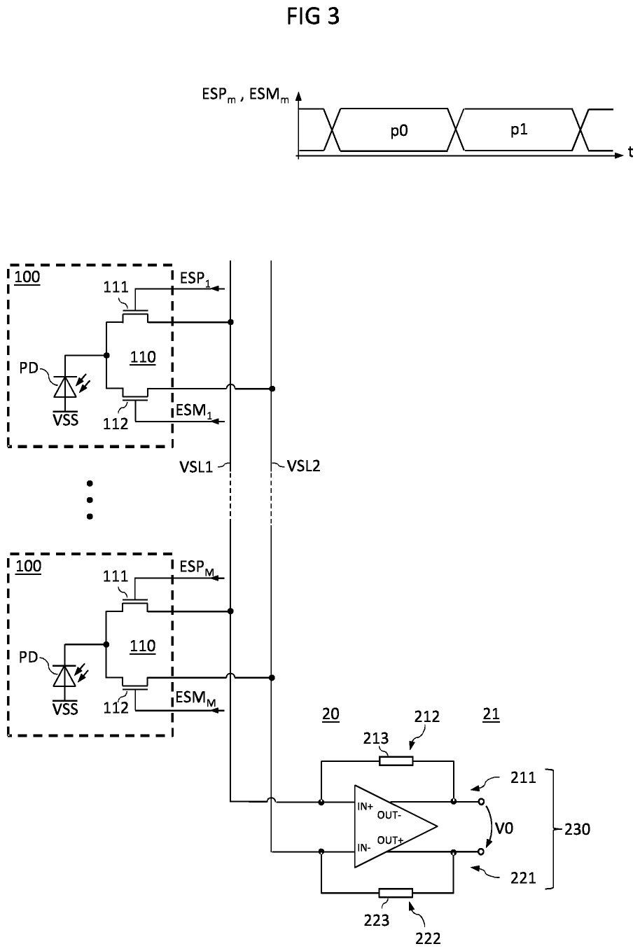

FIG. 3 to FIG. 5 show details of solid-state imaging device 90 with pixel circuits 100 including pixel encoding circuits 110, and with column readout circuits 20 including differential units 21 based on differential amplifiers with differential outputs.

Each pixel circuit 100 may include a first encoding switch 111 controlled by the row encoding signal ES and configured to pass the pixel signal to the first data signal line VSL1 when the row encoding signal ES is active, and a second encoding switch 112 configured to pass the pixel signal to the second data signal line VSL2 when the row encoding signal is not active.

The first and second encoding switches 111, 112 may be n-FETs of the enhancement type. A non-inverted instance ESP of the row encoding signal ES controls the first encoding switch 111 and an inverted instance ESM of the row encoding signal ES controls the second encoding switch 112. The first and second encoding switches 111, 112 form at least a portion of the pixel encoding circuit 110. The pixel encoding circuit 110 may include additional FETs for obtaining the inverted instance ESM from the non-inverted instance ESP of the row encoding signal ES. for obtaining the non-inverted instance ESP from the inverted instance ESM of the row encoding signal ES or for obtaining both the inverted instance ESM and the non-inverted instance ESP from a same row encoding source signal.

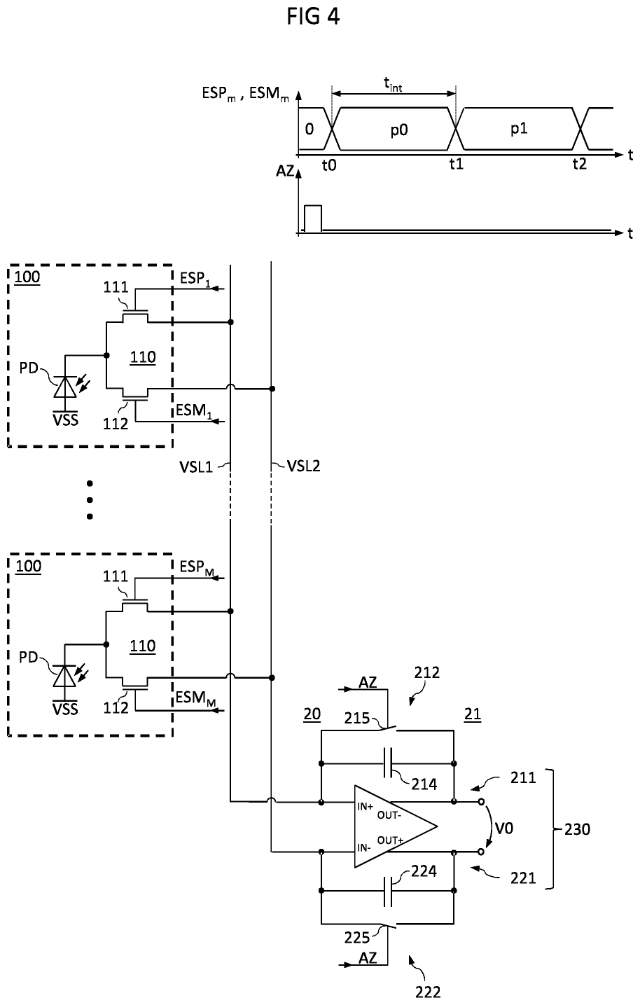

FIG. 3 and FIG. 4 show details of a solid-state imaging device 90 with passive pixel circuits 100.

Each pixel circuit 100 includes a photoelectric conversion device PD that generates a photocurrent, wherein the photocurrent is a function of a light intensity received by the photoelectric conversion device PD. The pixel signal output by each pixel circuit 100 is a current signal derived from the photocurrent of the photoelectric conversion device PD. In particular, the pixel signal may be identical to the photocurrent flowing through the pixel encoding circuit 110 to the first data signal line VSL1 or the second data signal line VSL2.

A first data signal line VSL1 connects first pixel outputs of a plurality of pixel circuits 100 with a first input of the column readout circuit 20. A second data signal line VSL2 connects second pixel outputs of the plurality of pixel circuits 100 with a second input of the column readout circuit 20. The pixel circuits 100 connected to the first data signal line VSL1 and to the same second data signal line VSL2 may include all pixel circuits 100 of one pixel column 31.

The column readout circuit 20 may convert a current obtained by superimposing the pixel signals on the first data signal line VSL1 into a first voltage signal, may convert a current obtained by superimposing the pixel signals on the second data signal line VSL2 into a second voltage signal, and may generate the differential signal DS from the first voltage signal and the second voltage signal.

More specifically, the pixel circuits 100 connected to the same signal line pair simultaneously output the photocurrents to the signal line pair, and the column readout circuit 20 includes a differential unit 21 that superimposes the photocurrents simultaneously passed to the first data signal line VSL1, superimposes the photocurrents simultaneously passed to the second data signal line VSL2 and obtains a differential voltage from a first voltage signal obtained by current-to-voltage conversion of the photocurrent passed to the first data signal line VSL1 and a second voltage signal obtained by current-to-voltage conversion of the photocurrent passed to the second data signal line VSL2.

Conversion of the pixel signals on the first data signal line VSL1 into the first voltage signal and conversion of the pixel signals on the second data signal line VSL2 into the second voltage signal may use the same gain factors and the differential signal DS may be obtained by subtracting the first voltage signal from the second voltage signal or by subtracting the second voltage signal from the first voltage signal.

For example, the column readout circuit 20 includes a first amplifier circuit 211 and a first feedback element 212 electrically connected between an output of the first amplifier circuit 211 and an input of the first amplifier circuit 211, wherein the input of the first amplifier circuit 211 is configured to receive the pixel signals transmitted on the first data signal line VSL1. The column readout circuit 20 includes a second amplifier circuit 221 and a second feedback element 222 electrically connected between an output of the second amplifier circuit 221 and an input of the second amplifier circuit 221, wherein the input of the second amplifier circuit 221 is configured to receive the pixel signals transmitted on the second data signal line VSL2.

In particular, the first data signal line VSL1 electrically connects the first pixel outputs of the pixel circuits 100 with the input of the first amplifier circuit 211 and the second data signal line VSL2 electrically connects the second pixel outputs of the pixel circuits 100 with the input of the second amplifier circuit 221

The first voltage signal output by the first amplifier circuit 211 is obtained by superposition and amplification of the voltages generated by the photocurrents of all pixel circuits 100 connected to the first data signal line VSL1 during the same pixel array readout. For example, the first voltage signal is obtained by superposition and amplification of the voltages generated across the first feedback element 212 by the photocurrents of all pixel circuits 100 encoded with the elemental value “+1”. The second voltage signal output by the second amplifier circuit 221 is obtained by superposition and amplification of the voltages generated by the photocurrents of all pixel circuits 100 connected to the second data signal line VSL2 during the same pixel array readout. For example, the second voltage signal is obtained by superposition and amplification of the voltages generated across the second feedback element 222 by the pixel signals photocurrents of all pixel circuits 100 encoded with the elemental value “−1”.

The first and second amplifier circuits 211, 212 may be separated amplifiers operating independently from each other. According to the illustrated embodiment, a differential amplifier 230 includes the functionality of the first and second amplifier circuits 211, 212.

In FIG. 3, the first feedback element 212 includes a first resistive element 213, and the second feedback element 222 includes a second resistive element 223. A resistance of the first resistive element 213 and a resistance of the second resistive element 223 may be equal.

The resistance of the first and second resistive elements 213. 223 adjusts the voltage response. The response of the column readout circuit 20 can be comparatively fast. Further components electrically connected in series with the first and second feedback elements 213, 223 may be provided to obtain a non-linear current-voltage transfer function.

In FIG. 4, the first feedback element 212 includes a first capacitive element 214 and a first controllable switch 215 electrically connected in parallel, and the second feedback element 222 includes a second capacitive element 224 and a second controllable switch 225 electrically connected in parallel.

In particular, the first voltage signal output by the first amplifier circuit 211 is obtained by integrating and amplifying the photocurrents superimposing on the first data signal line VSL, and the second voltage signal output by the second amplifier circuit 221 is obtained by integrating and amplifying the photocurrents superimposing on the second data signal line VSL2. The capacitances of the first capacitive element 214 and the second capacitive element 224 may be equal.

An auto zero signal AZ may control the first controllable switch 215 and the second controllable switch 225. In particular, the auto zero signal AZ may simultaneously turn on the first controllable switch 215 and the second controllable switch 225 for a sufficiently long time to reliably discharge the first capacitive element 214 and the second capacitive element 224 prior to reading out the pixel signals.

For this integration scheme, each output voltage VO is relative to the previous value. Thus, a capacitor reset is needed to start the readout sequence with a zero voltage across the first capacitive element 214 and the second capacitive element 224. Each frame readout starts with an active auto zero signal AZ turning on the first controllable switch 215 to discharge the first capacitive element 214 and turning on the second controllable switch 225 to discharge the second capacitive element 224. Since only the first controllable switch 215 and the second controllable switch 225 need the auto zero signal AZ, the first controllable switch 215 and the second controllable switch 225 can be located outside of the pixel array 11. Without discharging the first capacitive element 214 and the second capacitive element 224. the output voltage VO might become too large over time.

The non-inverted instances ESP and the inverted instance ESM of the row encoding signals ESₖ for the start pattern 0 are either all active (all encoding switches 111, 112 on) or all inactive (all encoding switches 111, 112 off). When at t=10 the ESP/ESM pattern changes from 0 to p0 and at t=t1 the ESP/ESM pattern changes from p0 to p1, the pattern output voltage Vp0 related to ESP/ESM pattern p0 is Vp0=VO(t1)−VO(t0), and the output voltage related to ESP/ESM pattern p1 is Vp1=VO (t2)−VO(t1), etc.. The time duration for a ESP/ESM pattern px between a pattern change from ESP/ESM pattern p(x−1) to px and a pattern change from ESP/ESM pattern px to p(x+1) is the exposure time, and the pattern voltages Vp0, Vp1 . . . , are directly proportional to the exposure time.

The integration approach makes the readout more robust against high frequency noise at the cost of some additional delay due to the integration time constant.

Further components electrically connected in series with the first and second capacitive elements 214, 224 may be provided to obtain a non-linear current-voltage transfer function.

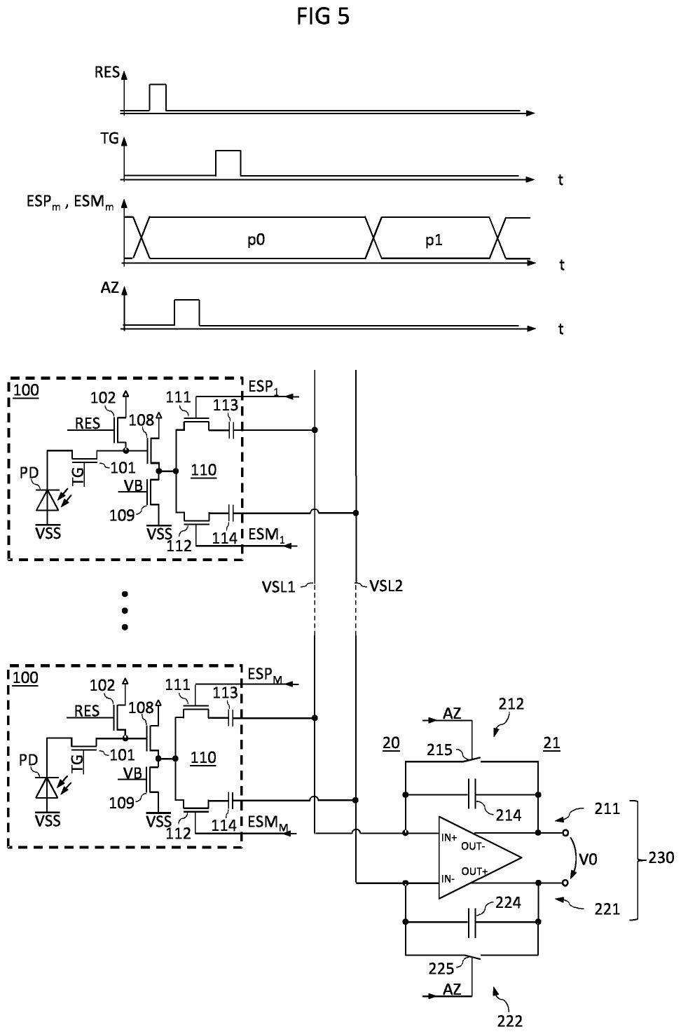

FIG. 5 shows details of a solid-state imaging device 90 with active pixel circuits 100. The pixel circuits 100 may be any active pixel sensors suitable for intensity readout.

Each pixel circuit 100 includes a photoelectric conversion device PD that generates a photocurrent, wherein the photocurrent is a function of a light intensity received by the photoelectric conversion device PD, and wherein the pixel signal is a voltage signal derived from a charge accumulated by the photocurrent within an exposure period.

For example, the pixel signal may be derived from a voltage obtained by pre-charging a capacitive element and then continuously discharging the capacitive element by the photocurrent. Alternatively, the pixel signal may be derived from a voltage obtained by continuously charging a capacitive element by the photocurrent. The photoelectric conversion element PD may include or may be composed of, for example, a photodiode that converts electromagnetic radiation incident on a detection surface into a detector current by means of the photoelectric effect. In the intensity range of interest, the detector current increases approximately linearly with increasing intensity of the detected electromagnetic radiation.

The pixel circuit 100 may include more than one photoelectric conversion device PD, wherein the photoelectric conversion devices PD may differ in sensitivity. For simplicity, the example shown in FIG. 5 refers to pixel circuits 100 having one photoelectric conversion element PD and three active FETs as pixel transistors. Other examples may include two photoelectric conversion elements having different sensitivities and more than three active pixel transistors.

Each pixel circuit 100 may further include a floating capacitance FC and a source follower circuit 107. The floating capacitance FC is configured to be charged or discharged by the photocurrent of the photoelectric conversion element. The source follower circuit 107 is configured to be controlled by a voltage across the floating capacitance FC, wherein the pixel signal is derived from an output signal of the source follower circuit 107.

The source follower circuit 107 may include an output transistor 108 and a source load 109. The output transistor 108 is an FET in a source follower configuration with a transistor load path between the positive supply voltage VDD and the source load 109. The source load 109 may include a resistive element and/or a FET with constant gate bias. The output signal of the source follower circuit 107 is available at an output node between the source of the output transistor 108 and the source load 109. The output transistor 108 outputs the pixel signal via the output node, wherein the voltage amplitude of the pixel signal is a function of the floating capacitance potential Vfc of the floating capacitance FC.

When the first encoding switch 111 is on, the output node may be capacitively coupled to the first data signal line VSL1. When the second encoding switch 111 is on, the output node may be capacitively coupled to the second data signal line VSL2.

In addition to the floating capacitance FC and the source follower circuit 107, each pixel circuit 100 may include at least a transfer transistor 101 and a reset transistor 102.

The transfer transistor 101 is electrically connected between the cathode of the photoelectric conversion element PD and a floating capacitance FC. The transfer transistor 101 serves as transfer element for transferring charge from the photoelectric conversion element PD to a storage electrode of the floating capacitance. The storage electrode of the floating capacitance FC may include a floating diffusion region. The floating capacitance FC serves as local, temporary charge storage. A transfer signal TG is supplied to the gate (transfer gate) of the transfer transistor 101 through a transfer control line. Thus, the transfer transistor 101 may transfer electrons photoelectrically converted by the photoelectric conversion element PD to the floating capacitance FC. The transfer control line is an example of a row control line RL as described above. The transfer signal TG is an example of a row control signal as described above.

The reset transistor 102 is connected between the floating capacitance FC and a power supply line to which a positive supply voltage VDD is supplied. A reset signal RES is supplied to the gate of the reset transistor 102 through a reset control line. Thus, the reset transistor 102 serving as a reset element resets the floating capacitance potential Vfc of the floating capacitance FC to that of the power supply line supplying the positive supply voltage VDD. The reset control line is another example of a row control line RL as described above. The reset signal RES is another example of a row control signal as described above.

An active reset signal RES for all pixel circuits 100 read out with the same encoding matrix may precede an active auto zero signal AZ. An active transfer signal TG for all pixel circuits 100 read out with the same encoding matrix may follow the active auto zero signal AZ.

The floating capacitance FC is connected to the gate of the output transistor 108. The floating capacitance FC functions as the input node of the source follower circuit 107. The voltage amplitude of the pixel signal across the first coupling capacitor 113 or the second coupling capacitor 114 is a function of the floating capacitance potential Vfc.

The pixel circuits 100 and the column readout circuit 20 are configured to superimpose the pixel signals passed to the first data signal line VSL1 into a first voltage signal by a first capacitive summing amplifier, to superimpose the pixel signals on the second data signal line VSL1 into a second voltage signal by a second capacitive summing amplifier, and to generate the differential signal DS from the first voltage signal and the second voltage signal. Each differential signal DS may be obtained by subtracting the first voltage signal from the second voltage signal or by subtracting the second voltage signal from the first voltage signal

Each pixel circuit 100 may include a coupling circuit 115 capacitively coupling the pixel circuit 100 to the first data signal line VSL1 and the second data signal line VSL2.

For example. the coupling circuit 115 includes a first coupling capacitor 113 coupling the pixel circuit 100 to the first data signal line VSL1 and a second coupling capacitor 114 coupling the pixel circuit 100 to the second data signal line VSL1. In particular, the first coupling capacitor 113 may be connected between the first encoding switch 111 and the first data signal line VSL1. and the second coupling capacitor 114 may be connected between the second encoding switch 112 and the second data signal line VSL2.

The first encoding switch 111 is electrically connected between the output node and a first electrode of a first coupling capacitor 113. A second electrode of the first coupling capacitor 113 is connected to the first data signal line VSL1. The second encoding switch 112 is electrically connected between the output node and a first electrode of a second coupling capacitor 114. A second electrode of the second coupling capacitor 114 is connected to the second data signal line VSL2.

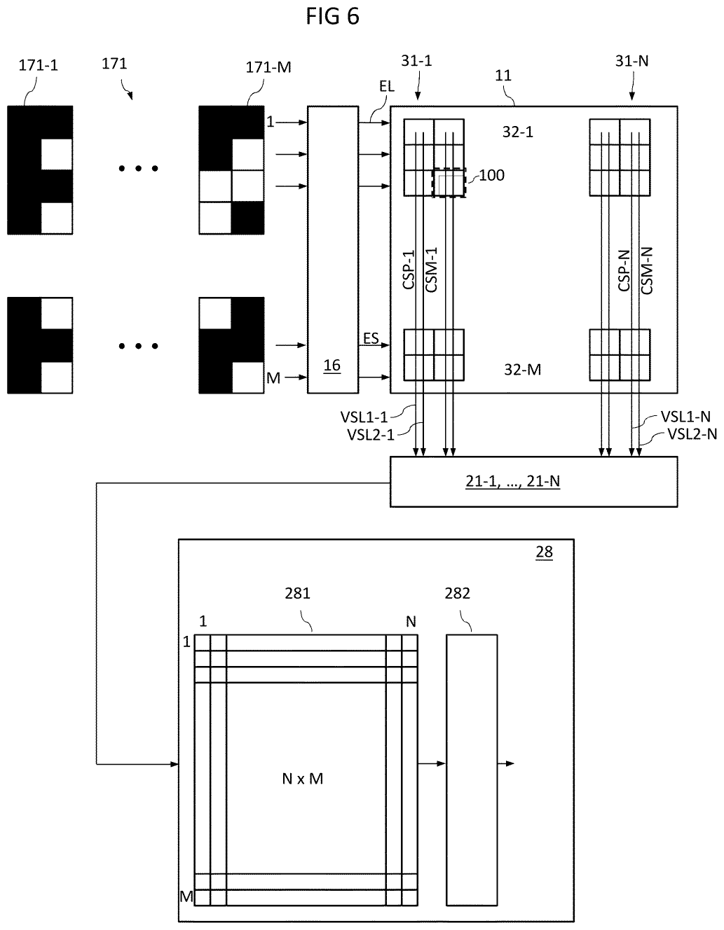

FIG. 6 gives an overview of the encoding and decoding process for a CDMA readout of a pixel array 11 with a plurality of pixel circuits 100 arranged in N pixel columns 31-1, . . . , 31-N and M pixel rows 32-1, . . . , 32-M.

An encoding unit 16 uses an M×M binary spreading code matrix 171 to generate encoding signals ES. The M×M binary spreading code matrix 171 contains M different code words 171-1, . . . , 171-M. wherein each code word 171-1, . . . 171-M includes M code elements. The binary spreading code matrix 171 may be a Walsh-Hadamard matrix. Each code element has an element value “+1” indicated by a white square or an element value “−1” indicated by a black square.

For one encoding period. the encoding unit 16 applies one of the code words 171-1, . . . , 171-M to each of the N pixel columns 31-1, . . . , 31-N by converting element values “+1” interactive encoding signals and element values “-1” into inactive encoding signals on row encoding lines EL. Each of the pixel circuits 100 outputs the pixel signal to a first data signal line in case the encoding unit 16 applies an active encoding signal. Each of the pixel circuits 100 outputs the pixel signal to a second data signal line in case the encoding unit 16 applies an inactive encoding signal.

The pixel signals on the first data signal lines VSL1-1, . . . , VSL-N superpose to first column signals CSP-1, . . . , CSP-M on the first data signal lines VSL1-1, . . . , . VSL1-N. wherein each first data signal line VSL1-1, . . . , VSL1-N connects the first outputs of the pixel circuits 100 of a pixel column 31-1, . . . , 31-N with a first input of the column readout circuit 20-1, . . . , 20-N associated with the respective pixel column 31-1, . . . , 31-N. The pixel signals on the second data signal lines VS2-1, . . . , VSL2-N superpose to second column signals CSM-1, . . . , CSM-M on the second data signal lines VS2-1, . . . , VSL2-N. wherein each second data signal line VSL2-1, . . . , VSL2-N connects the second outputs of the pixel circuits 100 of a pixel column 31-1, . . . , 31-N with a second input of the column readout circuit 20-1, . . . , 20-N associated with the respective pixel column 31-1, . . . , 31-N. Each column readout circuit 20-1, . . . , 20-N. in particular the differential unit 21-1, . . . , 21-N associated with the respective pixel column 31-1, . . . , 31-N. generates a differential signal from each pair of a first column signal CSP-1, . . . , CSP-M and a second column signal CSM-1, . . . , . CSM-M and converts the differential signal into one digital column value per encoding period and pixel column 31-1, . . . , 31-N.

A complete frame readout period includes M encoding periods. wherein in each encoding period the encoding unit 16 applies another one of the code words 171-1, . . . , 171-M to each of the N pixel columns 31-1, . . . , 31-N. The column readout circuit 20-1, . . . , 20-N transfers the digital column values for each pixel column 31-1, . . . , 31-N and each code word 171-1, 171-M to a memory unit 281 of a digital block 28.

After a complete frame readout period, the memory unit 281 holds for each of the N pixel columns 31-1, . . . , 31-N an encoded word containing M digital column values. The digital block 28 further includes a decoder unit 282 that sequentially applies words of a decoding matrix to decode the M digital column values into the M pixel values. The decoding matrix may be the inverted binary spreading code matrix 171.

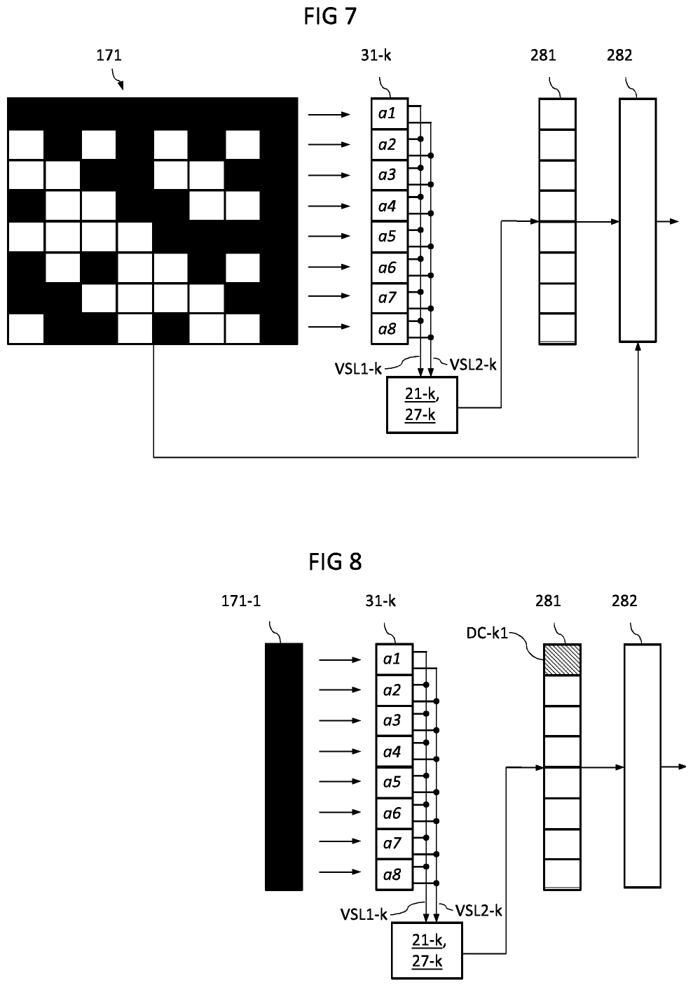

FIG. 7 through FIG. 10 illustrate the encoding process using a binary spreading code matrix 171 implemented as 8×8 Walsh-Hadamard code matrix and a pixel array with 8 pixel rows for simplicity. The eight pixel signals of the k-th pixel column 31-k have the amplitudes a1, a2, a3, a4, a5, a6, a7, a8 as illustrated in FIG. 7

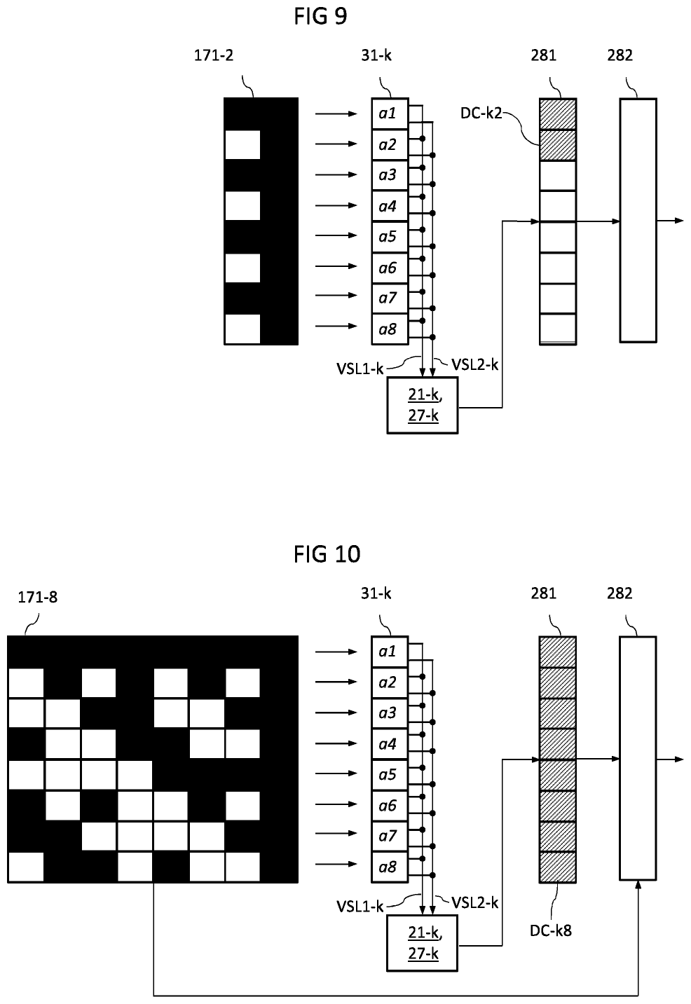

FIG. 8 shows application of the first code word 171-1 of the binary spreading code matrix 171 onto the k-th pixel column 31-k in a first encoding period. Each pixel signal is inverted, i.e. forwarded to the second data signal line VSL2. The resulting first differential signal of the k-th pixel column 31-k has the amplitude aDS1=−a1−a2−a3−a4−a5−a6−a7−a8. The first differential signal DSI is converted into a first digital column value DC-k1 of the k-th pixel column 31-k and stored as first element in the k-th column of a memory unit 281.

FIG. 9 shows application of the second code word 171-2 of the binary spreading code matrix 171 onto the k-th pixel column 31-k in a second encoding period. Each odd pixel signal is inverted. i.e. forwarded to the second data signal line VSL2. The other pixel signals are not inverted. i.e. forwarded to the first data signal line VSL1. The resulting second column signal CS2 of the k-th pixel column 31-k has the amplitude aCS2=−a1+a2−a3+a4−a5+a6−a7+a8. The second column signal CS2 is converted into a second digital column value DC-k2 of the k-th pixel column 31-k and stored as second element in the k-th column of the memory unit 281.

FIG. 10 shows application of the eighth code word 171-8 of the binary spreading code matrix 171 onto the k-th pixel column 31-k in an eighth encoding period. The first, the fourth, the sixth and the seventh pixel signal are inverted, i.e. forwarded to the second data signal line VSL2. The other pixel signals are not inverted, i.e. forwarded to the first data signal line VSL1. The resulting eighth column signal CS8 of the k-th pixel column 31-k has the amplitude aCS8=−a1+a2+a3−a4+a5−a6−a7+a8. The eighth column signal CS8 is converted into an eighth digital column value DC-k8 of the k-th pixel column 31-k and stored as eighth element in the k-th column of a memory unit 281.

A complete frame readout period includes all eight encoding periods. Within the same frame readout period, the pixel signals on which the encoding is applied, in substance do not change. As far as the pixel output signals do slightly change, e.g. as a result of noise, the restored signal represents an averaged value across the eight pixel signals for the eight encoding periods.

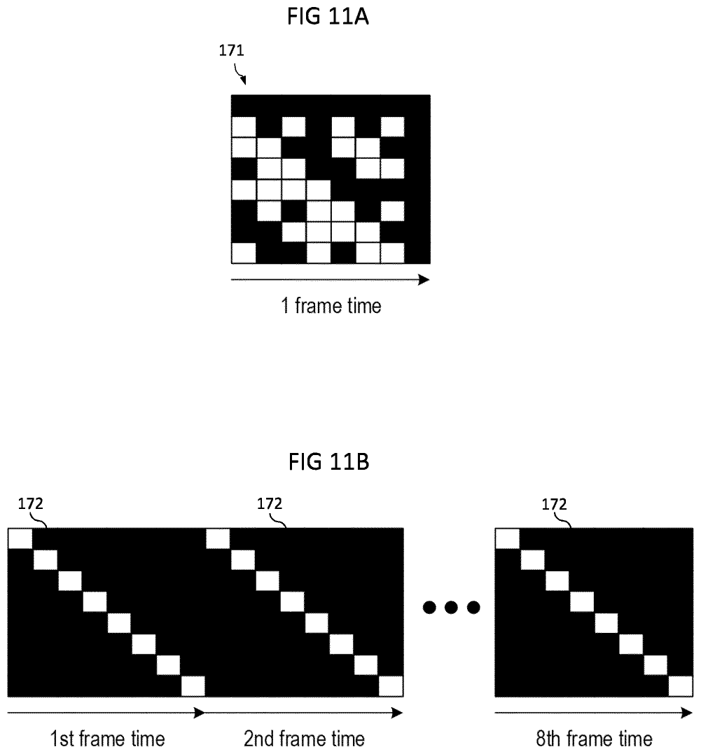

FIG. 11A shows a typical binary spreading code matrix 171 of the Walsh-Hadamard type. Each coded readout reads out all pixel circuits 100 of a pixel column such that the same pixel signal is read out 8 times, that is once for each of the code words of the binary spreading code matrix 171. The inherent averaging effect for each pixel signal improves the SNR by √8.

In contrast, in a conventional row-by-row readout as schematically illustrated in FIG. 11B, each pixel circuit 100 is only read out “once” per frame readout period, as indicated by the white squares in the matrices 172. To achieve the same improvement in SNR by averaging, eight complete frames are necessary.

That is, for achieving the same SNR in the same frame readout period, the CDMA encoded readout allows reducing the supply voltages in a pixel array by VM and thus may contribute to a significant reduction of power consumption in a solid-state imaging device.

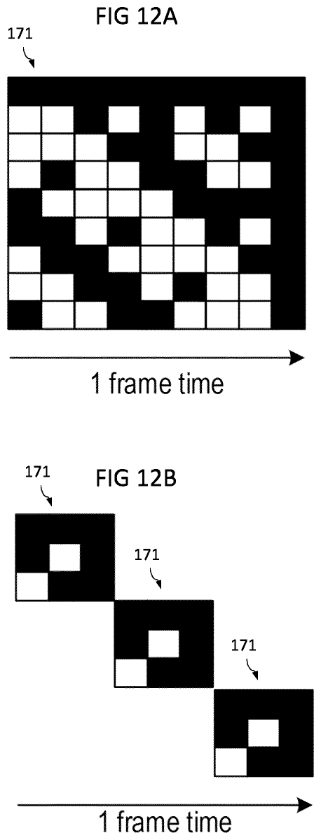

FIG. 12A and FIG. 12B refer to an adaptive embodiment of the encoding unit 16 as illustrated in FIG. 1 and FIG. 2 for an illustrative example with a binary spreading code matrix with a number M of code words M=9. Typically the number M of code words is greater than 1000.

In particular, the encoding unit 16 may change between a first encoding mode and a second encoding mode in response to an encoder control signal. In the first encoding mode the encoding unit 16 uses a first binary spreading code matrix with a code length L equal to the number M of pixel circuits 100 per pixel column 31. In a second encoding mode, the encoding unit 16 uses a second binary spreading code matrix with a code length L less than the number M of pixel circuits 100 per pixel column 31.

FIG. 12A shows the 9×9 binary spreading code matrix 171 used for the first encoding mode. All M pixel rows 32-1, . . . , 32-M are addressed and read out simultaneously in each encoding period.

For the second encoding mode, the pixel rows are grouped into two or more sets of pixel rows 32-1, . . . , 32-L with L<M. The pixel rows of the same set of pixel rows 32-1, . . . , 32-L are addressed and encoded simultaneously in the same encoding period. L may be an integer divisor of M to allow application of the same binary spreading code matrix 171 to all sets of pixel rows 32-1, . . . , 32-L.

FIG. 12B shows a 3 x 3 binary spreading code matrix 171 sequentially applied to three sets of pixel rows 32-1, . . . , 32-L.

The encoder control signal may be generated in the sensor controller 15 of FIG. 1, FIG. 2 or FIG. 4 in response to a change of an internal state or a user setting.

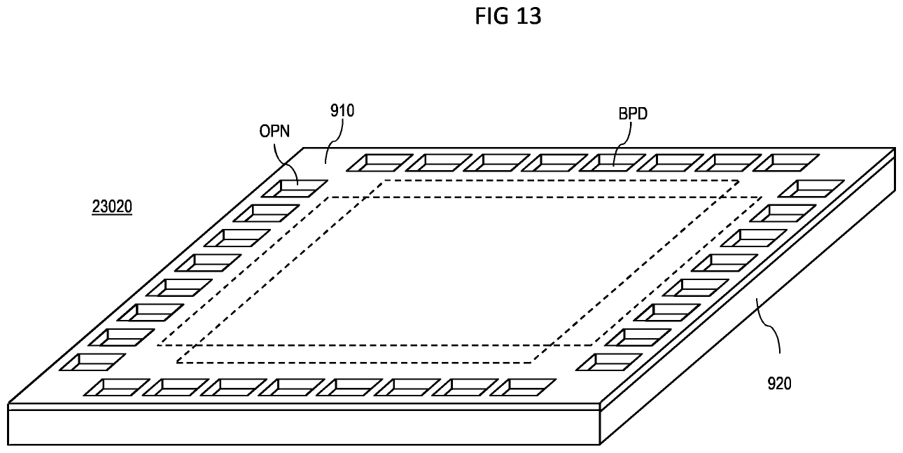

FIG. 13 is a perspective view showing an example of a laminated structure of a solid-state imaging device 23020 with a plurality of pixel circuits arranged matrix-like in array form. Each pixel circuit includes at least one photoelectric conversion element.

The solid-state imaging device 23020 has the laminated structure of a first chip (upper chip) 910 and a second chip (lower chip) 920.

The laminated first and second chips 910, 920 may be electrically connected to each other through TC(S) Vs (Through Contact (Silicon) Vias) formed in the first chip 910.

The solid-state imaging device 23020 may be formed to have the laminated structure in such a manner that the first and second chips 910 and 920 are bonded together at wafer level and cut out by dicing.

In the laminated structure of the upper and lower two chips, the first chip 910 may be an analog chip (sensor chip) including at least one analog component of each pixel circuit, e.g., the photoelectric conversion elements arranged in array form.

For example, the first chip 910 may include only the photoelectric conversion elements of the pixel circuits as described above with reference to the preceding FIGS. Alternatively, the first chip 910 may include further elements of each pixel circuit. For example, the first chip 910 may include, in addition to the photoelectric conversion elements, at least the transfer transistor, the reset transistor, the output transistor, and/or the source load of the pixel circuits. Alternatively, the first chip 910 may include each element of the pixel circuit.

The second chip 920 may be mainly a logic chip (digital chip) that includes the elements complementing the elements on the first chip 910 to complete pixel circuits and current control circuits. The second chip 920 may also include analog circuits, for example circuits that quantize analog signals transferred from the first chip 910 through the TCVs.

The second chip 920 may have one or more bonding pads BPD and the first chip 910 may have openings OPN for use in wire-bonding to the second chip 920.

The solid-state imaging device 23020 with the laminated structure of the two chips 910, 920 may have the following characteristic configuration:

The electrical connection between the first chip 910 and the second chip 920 is performed through, for example, the TCVs. The TCVs may be arranged at chip ends or between a pad region and a circuit region. The TCVs for transmitting control signals and supplying power may be mainly concentrated at, for example, the four corners of the solid-state imaging device 23020, by which a signal wiring area of the first chip 910 can be reduced.

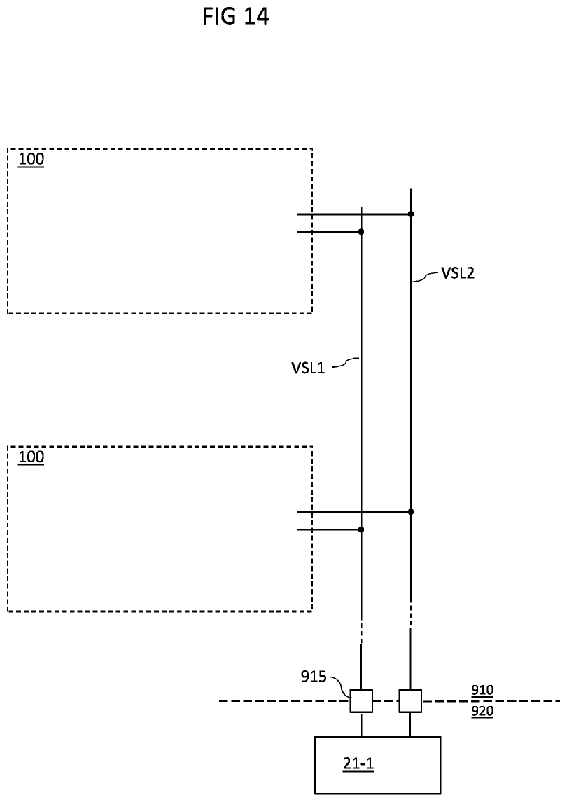

FIG. 14 shows another possible allocation of elements of a solid-stage imaging device across the first chip 910 and the second chip 920 of FIG. 14.

The first chip 910 may include the pixel circuits 100 with photoelectric conversion element, encoding circuit and, if applicable, pixel transistors and coupling circuit, and sections of the first and second data signal lines VSL1, VSL2 connecting the outputs of the pixel circuits 100 associated with the same pixel column on the first chip 910. The second chip 920 may include inter alia the column readout circuits 20-1 with the differential units 21-1, . . . . One contact structure 915, e.g. a through contact via, per data signal line VSL1, VSL2 may pass the pixel signals from the first chip 910 to the second chip 920.

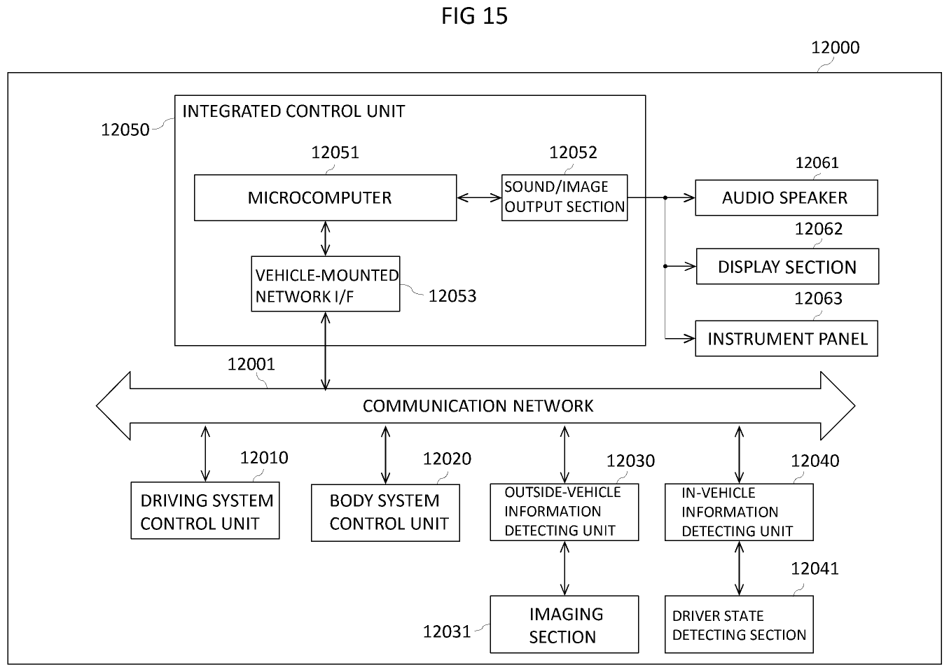

FIG. 15 is a block diagram depicting an example of schematic configuration of a vehicle control system as an example of a system to which the technology according to an embodiment of the present disclosure can be applied.

The vehicle control system 12000 includes a plurality of electronic control units connected to each other via a communication network 12001. In the example depicted in FIG. 15, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 imaging an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 may be or may include an image sensor assembly or a solid-state imaging device implementing a CDMA readout method according to the embodiments of the present disclosure. The light received by the imaging section 12031 may be visible light, or may be invisible light such as infrared rays or the like.

The in-vehicle information detecting unit 12040 detects information about the inside of the vehicle and may be or may include an image sensor assembly or a solid-state imaging device implementing a CDMA readout method according to the embodiments of the present disclosure. The in-vehicle information detecting unit 12040 is, for example, connected with a driver state detecting section 12041 that detects the state of a driver. The driver state detecting section 12041, for example, includes a camera that includes the solid-stage imaging device and that is focused on the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which information is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automatic driving, which makes the vehicle to travel autonomously without depending on the operation of the driver, or the like, by controlling the driving force generating device, the steering mechanism, the braking device, or the like on the basis of the information about the outside or inside of the vehicle which information is obtained by the outside-vehicle information detecting unit 12030 or the in-vehicle information detecting unit 12040.

In addition, the microcomputer 12051 can output a control command to the body system control unit 12020 on the basis of the information about the outside of the vehicle which information is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound or an image to an output device capable of visually or audible notifying information to an occupant of the vehicle or the outside of the vehicle. In the example of FIG. 17, an audio speaker 12061, a display section 12062, and an instrument panel 12063 are illustrated as the output device. The display section 12062 may, for example, include at least one of an on-board display or a head-up display.

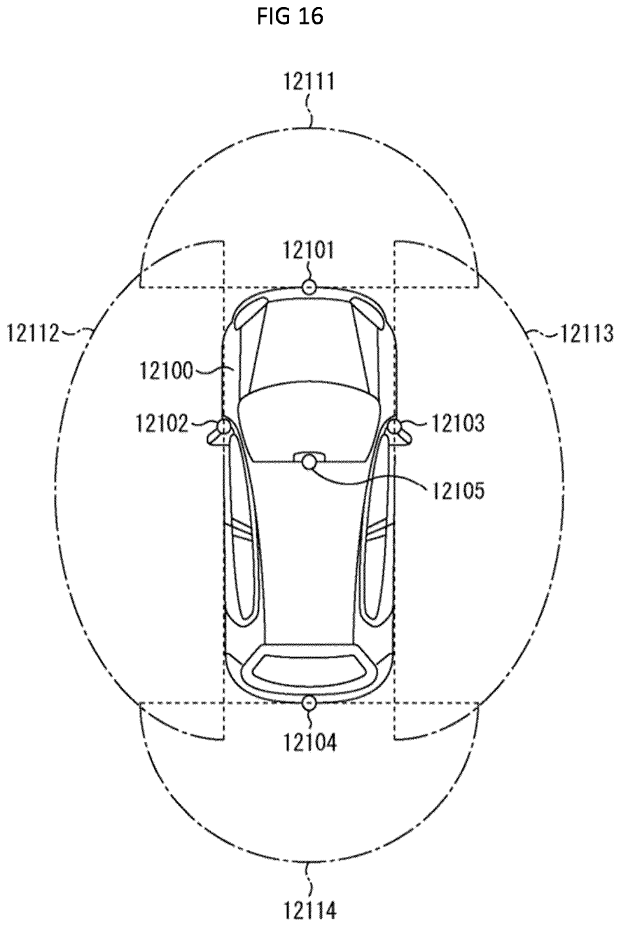

FIG. 16 is a diagram depicting an example of the installation position of the imaging section 12031, wherein the imaging section 12031 may include imaging sections 12101, 12102, 12103, 12104, and 12105.

The imaging sections 12101, 12102, 12103, 12104, and 12105 are, for example, disposed at positions on a front nose, side-view mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the side view mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 16 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the side view mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, imaging element having pixels for phase difference detection or may include a ToF module including an image sensor assembly or a solid-state imaging device implementing a CDMA readout method according to the embodiments of the present disclosure.

For example, the microcomputer 12051 can determine a distance to each three-dimensional object within the imaging ranges 12111 to 12114 and a temporal change in the distance (relative speed with respect to the vehicle 12100 on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automatic driving that makes the vehicle travel autonomously without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

The example of the vehicle control system to which the technology according to an embodiment of the present disclosure is applicable has been described above. By applying the an image sensor assembly or a solid-state imaging device implementing a CDMA readout method according to the embodiments of the present disclosure. the sensors have lower power consumption and better signal-to-noise ratio.

Additionally, embodiments of the present technology are not limited to the above-described embodiments, but various changes can be made within the scope of the present technology without departing from the gist of the present technology.

The solid-state imaging device according to the present disclosure may be any device used for analyzing and/or processing radiation such as visible light, infrared light, ultraviolet light, and X-rays. For example, the solid-state imaging device may be any electronic device in the field of traffic, the field of home appliances, the field of medical and healthcare, the field of security, the field of beauty, the field of sports, the field of agriculture, the field of image reproduction or the like.

Specifically, in the field of image reproduction, the solid-state imaging device may be a device for capturing an image to be provided for appreciation, such as a digital camera, a smart phone, or a mobile phone device having a camera function. In the field of traffic, for example, the solid-state imaging device may be integrated in an in-vehicle sensor that captures the front, rear, peripheries, an interior of the vehicle, etc. for safe driving such as automatic stop, recognition of a state of a driver, or the like, in a monitoring camera that monitors traveling vehicles and roads, or in a distance measuring sensor that measures a distance between vehicles or the like.

In the field of home appliances, the solid-state imaging device may be integrated in any type of sensor that can be used in devices provided for home appliances such as TV receivers, refrigerators, and air conditioners to capture gestures of users and perform device operations according to the gestures. Accordingly the solid-state imaging device may be integrated in home appliances such as TV receivers, refrigerators, and air conditioners and/or in devices controlling the home appliances. Furthermore, in the field of medical and healthcare, the solid-state imaging device may be integrated in any type of sensor, e.g. a solid-state image device, provided for use in medical and healthcare, such as an endoscope or a device that performs angiography by receiving infrared light.

In the field of security, the solid-state imaging device can be integrated in a device provided for use in security, such as a monitoring camera for crime prevention or a camera for person authentication use. Furthermore, in the field of beauty, the solid-state imaging device can be used in a device provided for use in beauty, such as a skin measuring instrument that captures skin or a microscope that captures a probe. In the field of sports, the solid-state imaging device can be integrated in a device provided for use in sports, such as an action camera or a wearable camera for sport use or the like. Furthermore, in the field of agriculture, the solid-state imaging device can be used in a device provided for use in agriculture, such as a camera for monitoring the condition of fields and crops.

The present technology can also be configured as described below:
(1) A solid-state imaging device, including: a pixel array including pixel circuits, wherein each pixel circuit is assigned to one of N pixel columns and to one of M pixel rows, each pixel circuit being configured to generate a pixel signal including pixel illumination information and to output the pixel signal depending on a signal level of a row encoding signal on a first data signal line or on a second data signal line: and a plurality of column readout circuits, each column readout circuit being configured to generate a first code signal by superimposing the pixel signals transmitted on the first data signal line, to generate a second code signal by superimposing the pixel signals transmitted on the second data signal line, and to generate a differential signal from the first code signal and the second code signal.
(2) The solid-state imaging device according to (1), further including: an encoding unit configured to control the row encoding signals according to a binary spreading code matrix with a number L of code words having a code length L, wherein the code length L is equal to or smaller than the number M of pixel circuits per pixel column.
(3) The solid-state imaging device according to any of (1) to (2), wherein each column readout circuit includes an analog-to-digital conversion unit configured to convert the analog differential signal into an encoded column value.
(4) The solid-state imaging device according to (3), wherein each column readout circuit includes a digital block configured to sequentially receive a set of the encoded column values and to decode the set of encoded column values by using the binary spreading code matrix, wherein the number of encoded column values per set is equal to the code length L of the binary spreading code matrix.
(5) The solid-state imaging device according to any of (1) to (4), wherein each pixel circuit includes a first encoding switch controlled by the row encoding signal and configured to pass the pixel signal to the first data signal line when the row encoding signal is active, and a second encoding switch configured to pass the pixel signal to the second data signal line when the row encoding signal is not active.
(6) The solid-state imaging device according to any of (1) to (5), wherein each pixel circuit includes a photoelectric conversion device configured to generate a photocurrent, wherein the photocurrent is a function of a light intensity received by the photoelectric conversion device, and wherein the pixel signal is a current signal derived from the photocurrent.
(7) The solid-state imaging device according to (6), wherein the column readout circuit is configured to convert a current obtained by superimposing the pixel signals on the first data signal line into a first voltage signal, to convert a current obtained by superimposing the pixel signals on the second data signal line into a second voltage signal, and to generate the differential signal from the first voltage signal and the second voltage signal.
(8) The solid-state imaging device according to any of (6) and (7), wherein the column readout circuit includes a first amplifier circuit and a first feedback element electrically connected between an output of the first amplifier circuit and an input of the first amplifier circuit and wherein the input of the first amplifier circuit is configured to receive the pixel signals transmitted on the first data signal line, and wherein the column readout circuit includes a second amplifier circuit and a second feedback element electrically connected between an output of the second amplifier circuit and an input of the second amplifier circuit and wherein the input of the second amplifier circuit is configured to receive the pixel signals transmitted on the second data signal line.
(9) The solid-state imaging device according to (8), wherein the first feedback element includes a first resistive element, and wherein the second feedback element includes a second resistive element.
(10) The solid-state imaging device according to (8), wherein the first feedback element includes a first capacitive element and a first controllable switch electrically connected in parallel to the first capacitive element. and wherein the second feedback element includes a second capacitive element and a second controllable switch electrically connected in parallel to the second capacitive element.
(11) The solid-state imaging device according to any of (1) to (5), wherein each pixel circuit includes a photoelectric conversion device configured to generate a photocurrent, wherein the photocurrent is a function of a light intensity received by the photoelectric conversion device, and wherein the pixel signal is a voltage signal derived from a charge accumulated by the photocurrent within an exposure period.
(12) The solid-state imaging device according to (11), wherein each pixel circuit further a floating capacitance and a source follower circuit, wherein the floating capacitance is configured to be charged or discharged by the photocurrent, wherein the source follower circuit is configured to be controlled by a voltage across the floating capacitance, and wherein the pixel signal is derived from an output signal of the source follower circuit.
(13) The solid-state imaging device according to any of (11) and (12), wherein the pixel circuits and the column readout circuit are configured to superimpose the pixel signals passed to the first data signal line into a first voltage signal by a first capacitive summing amplifier, to superimpose the pixel signals on the second data signal line into a second voltage signal by a second capacitive summing amplifier, and to generate the differential signal from the first voltage signal and the second voltage signal.
(14) The solid-state imaging device according to (13), wherein each pixel circuit includes a coupling circuit coupling the pixel circuit to the first data signal line and the second data signal line.
(15) A method of operating a solid-state imaging device, the method including: applying sequentially a number L of code words of a binary spreading code matrix to pixel columns of a two-dimensional pixel array, wherein each code word has a code length L, wherein each code word is applied to some or all of the pixel columns simultaneously with the bits of the code word simultaneously applied to different pixel rows of the pixel array, wherein for each of the pixel columns separately and depending on an element value of the binary spreading code matrix received by the pixel circuit, each pixel circuit outputs a pixel signal to a first data signal line or to a second data signal line; and generating a differential signal from a first code signal obtained from the pixel signals output to the first data signal line and from a second code signal obtained from the pixel signals output to the second data signal line.

1. A solid-state imaging device, comprising:
a pixel array comprising pixel circuits, wherein each pixel circuit is assigned to one of N pixel columns and to one of M pixel rows, each pixel circuit being configured to generate a pixel signal including pixel illumination information and to output the pixel signal depending on a signal level of a row encoding signal on a first data signal line or on a second data signal line; and
a plurality of column readout circuits, each column readout circuit being configured to generate a first code signal by superimposing the pixel signals transmitted on the first data signal line, to generate a second code signal by superimposing the pixel signals transmitted on the second data signal line, and to generate a differential signal from the first code signal and the second code signal.

2. The solid-state imaging device according to claim 1, further comprising:
an encoding unit configured to control the row encoding signals according to a binary spreading code matrix with a number L of code words having a code length L, wherein the code length L is equal to or smaller than the number M of pixel circuits per pixel column.

3. The solid-state imaging device according to claim 1,
wherein each column readout circuit comprises an analog-to-digital conversion unit configured to convert the analog differential signal into an encoded column value.

4. The solid-state imaging device according to claim 3,
wherein each column readout circuit comprises a digital block configured to sequentially receive a set of the encoded column values and to decode the set of encoded column values by using the binary spreading code matrix, wherein the number of encoded column values per set is equal to the code length L of the binary spreading code matrix.

5. The solid-state imaging device according to claim 1,
wherein each pixel circuit comprises a first encoding switch controlled by the row encoding signal and configured to pass the pixel signal to the first data signal line when the row encoding signal is active, and a second encoding switch configured to pass the pixel signal to the second data signal line when the row encoding signal is not active.

6. The solid-state imaging device according to claim 1,
wherein each pixel circuit comprises a photoelectric conversion device configured to generate a photocurrent, wherein the photocurrent is a function of a light intensity received by the photoelectric conversion device, and wherein the pixel signal is a current signal derived from the photocurrent.

7. The solid-state imaging device according to claim 6,
wherein the column readout circuit is configured to convert a current obtained by superimposing the pixel signals on the first data signal line into a first voltage signal, to convert a current obtained by superimposing the pixel signals on the second data signal line into a second voltage signal, and to generate the differential signal from the first voltage signal and the second voltage signal.

8. The solid-state imaging device according to claim 6,
wherein the column readout circuit comprises a first amplifier circuit and a first feedback element electrically connected between an output of the first amplifier circuit and an input of the first amplifier circuit and wherein the input of the first amplifier circuit is configured to receive the pixel signals transmitted on the first data signal line, and
wherein the column readout circuit comprises a second amplifier circuit and a second feedback element electrically connected between an output of the second amplifier circuit and an input of the second amplifier circuit and wherein the input of the second amplifier circuit is configured to receive the pixel signals transmitted on the second data signal line.

9. The solid-state imaging device according to claim 8,
wherein the first feedback element comprises a first resistive element, and wherein the second feedback element comprises a second resistive element.

10. The solid-state imaging device according to claim 8,
wherein the first feedback element comprises a first capacitive element and a first controllable switch electrically connected in parallel to the first capacitive element, and wherein the second feedback element comprises a second capacitive element and a second controllable switch electrically connected in parallel to the second capacitive element.

11. The solid-state imaging device according to claim 1,
wherein each pixel circuit comprises a photoelectric conversion device configured to generate a photocurrent, wherein the photocurrent is a function of a light intensity received by the photoelectric conversion device, and wherein the pixel signal is a voltage signal derived from a charge accumulated by the photocurrent within an exposure period.

12. The solid-state imaging device according to claim 11,
wherein each pixel circuit further a floating capacitance and a source follower circuit, wherein the floating capacitance is configured to be charged or discharged by the photocurrent, wherein the source follower circuit is configured to be controlled by a voltage across the floating capacitance, and wherein the pixel signal is derived from an output signal of the source follower circuit.

13. The solid-state imaging device according to claim 11,
wherein the pixel circuits and the column readout circuit are configured to superimpose the pixel signals passed to the first data signal line into a first voltage signal by a first capacitive summing amplifier, to superimpose the pixel signals on the second data signal line into a second voltage signal by a second capacitive summing amplifier, and to generate the differential signal from the first voltage signal and the second voltage signal.

14. The solid-state imaging device according to claim 13,
wherein each pixel circuit comprises a coupling circuit coupling the pixel circuit to the first data signal line and the second data signal line.

15. A method of operating a solid-state imaging device, the method comprising:
applying sequentially a number L of code words of a binary spreading code matrix to pixel columns of a two-dimensional pixel array, wherein each code word has a code length L, wherein each code word is applied to some or all of the pixel columns simultaneously with the bits of the code word simultaneously applied to different pixel rows of the pixel array, wherein for each of the pixel columns separately and depending on an element value of the binary spreading code matrix received by the pixel circuit, each pixel circuit outputs a pixel signal to a first data signal line or to a second data signal line; and
generating a differential signal from a first code signal obtained from the pixel signals output to the first data signal line and from a second code signal obtained from the pixel signals output to the second data signal line.
